(19) United States
(12) Patent Application Publication
(10) Pub. No.: US 2006/0138772 A1
(43) Pub. Date: Jun. 29, 2006

(54) Braze-free connector

(75) Inventors: Timothy Galante, West Hartford, CT (US); Sivakumar Gopalnarayanan, Simsbury, CT (US); Don A. Schuster, Lindale, TX (US); Craig Kersten, Mooresville, IN (US); Larry Burns, Avon, IN (US); Robert Dold, Agawam, MA (US)

Correspondence Address: WALL MARJAMA & BILINSKI, 101 SOUTH SALINA STREET, SUITE 400, SYRACUSE, NY, 13202, US

(73) Assignee: Carrier Corporation, Syracuse, NY (US)

(21) Appl. No.: 11/025,789

(22) Filed: Dec. 27, 2004

(51) Int. Cl. F16L 47/00

(52) U.S. Cl. 285/249

(57) ABSTRACT

A braze-free connector for attaching a flow line to an operating unit of a flow system. The connector has a central passage into which the flow line is inserted through a tapered entranceway. The entranceway opens into a radially expanded cavity that surrounds a section of the flow line. The cavity is filled with a pressure activated adhesive. A ferrule is mounted in the entranceway and is rotatably mounted upon a threaded nut which mates with a male thread on the connector body. As the nut is advanced, the ferrule moves axially into the cavity to activate the adhesive, and at the same time, is forced radially into tight sealing contact with the flow line.

### FIELD OF THE INVENTION

This invention relates to a braze-free connection for securing a flow line to an operating unit of a flow system.

### BACKGROUND OF THE INVENTION

This invention is ideally suited for joining a refrigerant line to an operating unit of an air conditioning unit such as a heat exchanger or the like. A good deal of the reliability of an air conditioning system is related to the skill of the technician who installs the system. The industry, however, is faced with a decrease in the number of skilled technicians for installing these types of systems. Among the tasks requiring the most skill and time to complete is the brazing of the refrigerant line connections. Any leaks in the connections reduces the amount of charge in the system causing the system to operate at less than optimum efficiency and such loss of charge can eventually lead to compressor and other system component failures.

A number of braze-free connectors have been developed in the prior art, which are generally referred to as quick connects. Quick connects were used to some extent in refrigeration systems back in the 1980s, but fell into disfavor because of leakage and reliability problems associated with these devices.

### SUMMARY OF THE INVENTION

It is therefore an object of the present invention to improve braze-free connectors, and in particular, braze-free connectors employed in refrigerant systems.

It is a further object of the present invention to improve the reliability of braze-free connectors used in refrigerant systems.

Yet another object of the invention is to provide a reliable braze-free connection for joining a refrigerant line to a component part of a refrigeration system.

These and other objects of the present invention are attained by a braze-free connector for attaching a flow line to an operating unit of a flow system. One end of the connector is permanently secure to the unit and contains a central flow passage that extends through the connector. The connector includes a radially expanded cavity that surrounds a section of the flow passage and an entranceway to the cavity that diverges from the free end face of the connector towards the cavity. A flow line is inserted into the entranceway and is passed through the cavity. A flowable pressure activated adhesive or sealant is stored in the cavity. An annular-shaped ferrule is slidably contained within the entranceway and a drive is arranged to move the ferrule axially into the entranceway to apply activating pressure upon the adhesive while at the same time the ferrule is compressed radially within the diverging section of the entranceway into the sealing contact with the refrigerant line.

### BRIEF DESCRIPTION OF THE DRAWINGS

For a better understanding of these and other objects of the invention, reference will be made to the following detailed description of the invention, which is to be read in association with the accompanying drawings, wherein:

FIG. 1 is a partial perspective view illustrating the connector of the present invention;

FIG. 2 is a partial perspective view in section illustrating a first embodiment of the invention;

FIG. 3 is a partial perspective view in section similar to that shown in FIG. 2 showing a flow line registered within the connector;

FIG. 4 is a partial perspective view illustrating a second embodiment of the invention;

FIG. 5 is a partial perspective view similar to FIG. 4 showing a flow line registered against an internal stop located in the connector housing; and

FIG. 6 is a further partial view in perspective illustrating the pressure sensitive adhesive after the adhesive has been activated.

### DETAILED DESCRIPTION OF THE INVENTION

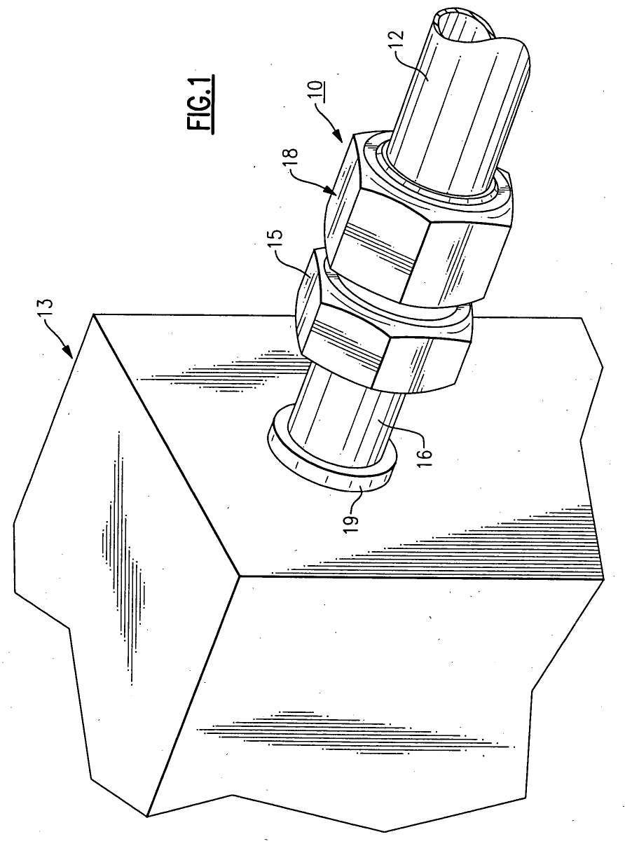

Turning initially to FIGS. 1-3, there is illustrated a first embodiment of the present invention which involves a connector, generally referenced 10 embodying the teachings of the present invention in which a refrigerant line 12 is joined in fluid flow communication to an operative unit of an air conditioning system such as a heat exchanger 13 or the like. Although the invention will be explained with specific reference to an air conditioning or refrigeration system, it should be pointed out that it may have broader applications in many different types of flow systems in which a brazed connection can be replaced by the non-brazed connection as herein described.

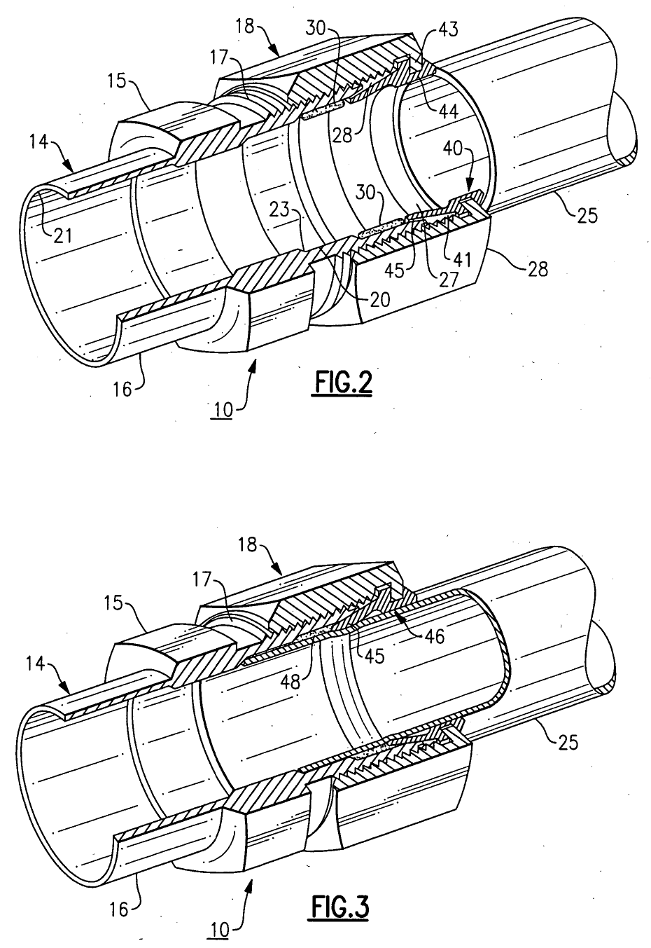

As best illustrated in FIGS. 2 and 3, the connector 10 includes a main body 14 that is generally tubular in form and having a hex headed section 15 that is integral with the tubular body section. The rear section of the body is joined to the operative unit 13 of the air conditioning system by a permanent fitting 19 to create a leak tight joint so that refrigerant can flow in and out of the unit through the connector. The front section of the connector body contains a male thread 17 that is arranged to mate with the female threads of a hex head nut 18.

The body section of the connector has a central passage that includes a first bore section 20 and a second bore section 21 that is coaxially aligned with said first bore section. The first bore section passes inwardly through an entranceway 27 located at the front face 28 of the body and has a diameter that is slightly larger than the second bore section 21. A radially disposed shoulder 23 is established between at the point where the two bore sections meet at about the midsection of the body. The first bore section is arranged to provide a close running fit with refrigerant line 25, which is slidably received into the connector through entranceway 27. In assembly, the refrigerant line is inserted into the connector body through the entranceway until it is arrested against the shoulder 23 (see FIG. 3).

A radially expanded cavity 30 is contained within the first bore section 20 which surrounds the refrigerant line when the line is arrested against shoulder 23. The entranceway 27 at the front end of the connector body is axially aligned with the central bore and diverges uniformly from the front face 28 of the body toward the cavity so that the throat opening to the cavity has a diameter that is slightly larger than the diameter of the first bore section 20.

An annular-shaped ferrule 40 to pass through the throat into the cavity is mounted within the entranceway 27 and contains a tapered outer surface 41 that compliments the diverging inner wall surface of the entranceway. The back end 41 of the ferrule contains a raised flange 43 that is arranged to ride in a circular groove 44 formed in the inner wall of nut 18. The inside diameter of the ferrule is slightly larger than the outside diameter of the refrigerant line. Initially, prior to threading the nut 18 onto the body of the connector, the ferrule and nut assembly is slipped onto the end of the refrigerant line and passed back a sufficient distance so that the end of the refrigerant line can be registered against shoulder 23. Once the line is registered, the nut is moved forward over the line and is mated with the threads 17 on the connector body. As the nut is tightened, the tip 45 of the ferrule moves into the cavity and is forced downwardly in a radial direction by the diverging inner wall of entranceway 27. The tip end of the ferrule is driven into locking contact with the registered refrigerant line to create a secure seal at the entrance to the cavity 30.

Prior to threading the nut assembly onto the connector, the cavity region surrounding the refrigerant line is filled with a pressure actuated adhesive 48 (FIG. 2). The ferrule penetrates sufficiently into the adhesive as the nut is advanced so that a pressure is built up in the cavity that is high enough to activate the adhesive. One form of adhesive that is well-suited for providing a strong leak tight joint between a copper refrigerant line and a metal connector body involves an epoxy resin that contains microencapsulated beads which house a liquid hardener for curing the resin. The beads as designed to burst when the pressure in the mixture reaches a given activation level whereupon the hardener flows throughout the cavity to create a mixture which when cured forms an extremely strong leak tight joint between the refrigerant line and the connector body.

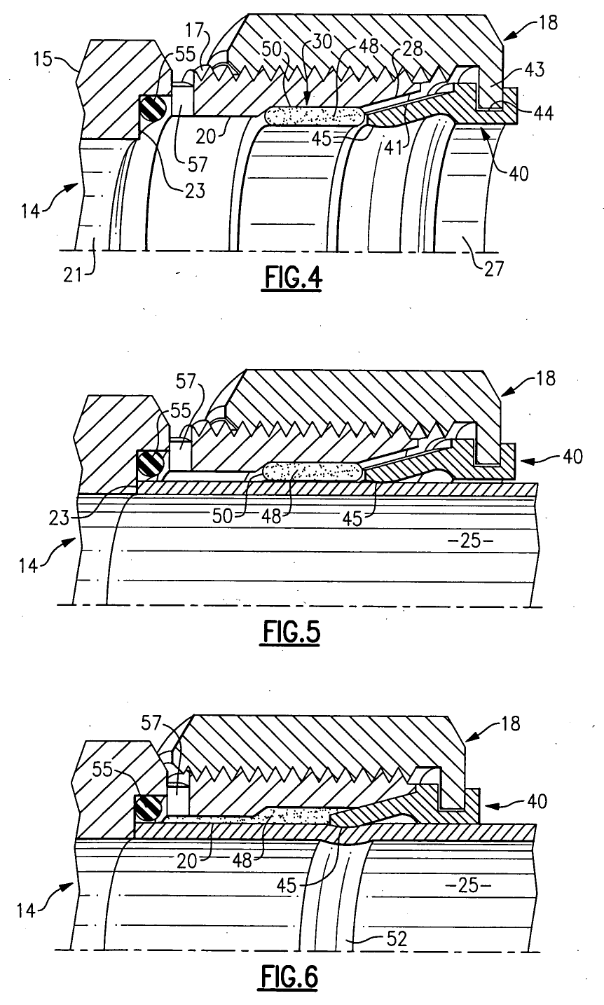

Turning now to FIGS. 4-6, there is shown a further embodiment of the present invention wherein like parts previously disclosed with reference to the above noted first embodiment are identified by like numbers. Here again, the rear section of the connector 10 is secured to a operative unit 13 of an air conditioning system and the front section of the connector contains a hex head nut 18 that is threadable onto the connector body 14. An annular-shaped ferrule generally referenced 40 is rotatably secured to the nut and is advanced axially into the entranceway as the nut advances upon the male threads 17. The entranceway again has a tapered inner wall that opens into cavity 30. A complimentary tapered outer surface on the ferrule 40 co-acts with that on the connector body to force the tip 45 of the ferrule radially into secure locking and sealing engagement with a refrigeration line 25 that is registered against shoulder 23.

In this embodiment of the invention, the pressure activated adhesive 48 is stored inside a flaccid pouch 50 that is arranged to fit snuggly within the cavity 30. As explained in detail above, the tip of the ferrule 40 is moved into the cavity as the nut 18 is advanced and is allowed to penetrate the pouch causing the pouch to burst at a given pressure, which is the activation pressure of the adhesive. The adhesive is now allowed to flow into the joint region surrounding the refrigerant line, where it will cure to provide a secure leak tight seal. An O-ring seal 55 is mounted within the connector body at about the shoulder 23. The O-ring is arranged to engage the leading edge of the refrigerant line 25 and seal this end of the first bore 20 of the connector body.

When the flaccid pouch bursts, it will produce a clearly audible noise thus alerting the technician that the adhesive has been activated. In addition, a small, clear window 57 is provided in the connector body that allows the technician to view the joint region. In most cases, the adhesive has a clearly discernable color. As the adhesive flows past the window, it will provide a visual indication that the adhesive has been activated. A colorant may also be added to the adhesive to enhance the visual presentation.

While this invention has been particularly shown and described with reference to the preferred embodiment in the drawings, it will be understood by one skilled in the art that various changes in its details may be effected therein without departing from the teachings of the invention.

What is claimed is:

1. A connector for providing a braze-free connection between a flow line and a component part of a flow system, wherein said connector includes:
a tubular body having a central passage passing through said body from a first end of said body to a second end of said body;
said first end of said body being connected in fluid flow communication with the component part of the flow system and a flow line slidably received in the passage through the second end of said body;
a radially expanded cavity in said passage that surrounds said flow line, said cavity containing a pressure activated adhesive;
said passage further includes an entranceway located at said second end of said body that opens into said cavity, said entranceway having an interior wall surface that diverges from said other end of said body toward said cavity;
a ferrule mounted in said entranceway in sliding contact with said interior surface of said entranceway; and
drive means for moving the ferrule axially within the entranceway toward said cavity so that said ferrule applies an activating pressure upon the adhesive contained within said cavity and said ferrule is compressed radially by said diverging wall of said entranceway into sealing contact with the flow line.

2. The connector of claim 1, wherein said adhesive is contained within a rupturable pouch that is ruptured by the ferrule as it moves axially in the entranceway.

3. The connector of claim 1, wherein said adhesive is a curable resin that contains microencapsulated beads housing a hardener for curing said resin, said beads being ruptured as the ferrule moves axially within said entranceway.

4. The connector of claim 1, wherein said body contains a mechanical seal for providing a seal between the flow line and the body at the back of said cavity.

5. The connector of claim 4, wherein said mechanical seal is an O-ring.

6. The connector of claim 1, wherein said passage contains a stop for limiting the depth of penetration of the flow line within said passage.

7. The connector of claim 6, wherein said stop includes a radially deposed shoulder located within said passage between said cavity and said first end of the connector body.

8. The connector of claim 1, wherein said drive means include an internally threaded member that is rotatably mounted upon said ferrule and which mates with an external male thread located upon said body.

9. The connector of claim 1 that further includes indicator means for signaling when the adhesive has been activated.

10. The connector of claim 9, wherein said indicator means provides an audible signal when the adhesive is activated.

11. The connector of claim 9, wherein said indicator means provides a visual signal when the adhesive is activated.

12. The connector of claim 11, wherein said indicator means includes a window for viewing adhesive contained within said passage.

13. A connector for providing a braze-free joint between a refrigerant line and a component part of a refrigeration system, wherein said connector includes:
a body having a flow passage passing between a first end of the body and a second end of said body;
means for joining said first end of said body in fluid flow communication with a component part of an air conditioning system;
an entranceway located at the second end of said body through which a refrigerant line is passed into said passage;
a radially expanded cavity in said passage that surrounds said refrigerant line, said cavity being filled with a pressure activated adhesive; and
a means for pressure activating said adhesive whereby a leak tight joint is established between the refrigerant line and the connector body.

14. The connector of claim 13, wherein said entranceway contains an inclined wall surface that tapers inwardly from the second end of said body toward the said cavity.

15. The connector of claim 14, wherein said means to activate said adhesive includes a ferrule that is arranged to ride in contact with said inclined wall surface and a drive means for moving said ferrule axially within said entranceway toward said cavity wherein said ferrule applies an activating pressure upon the adhesive contained within said cavity and simultaneously therewith said ferrule is compressed radially by said inclined surface of said entranceway into tight sealing contact with the flow line.

16. The connector of claim 15, wherein said drive means includes an internally threaded member that is rotatably mounted upon said ferrule that mates with external threads located upon said body.

17. The connector of claim 13, wherein a close running fit is provided between the inner wall of said passage and the outer wall of said refrigerant line.

18. The connector of claim 17 that further includes a stop means located in said passage between the cavity and said second end of said body for intercepting the refrigerant line, thus limiting the depth of penetration of the flow line into the body.

19. The connector of claim 18 that further includes a mechanical seal mounted in said body between said stop means and the cavity for providing a seal between the body and said refrigerant line.

20. The connector of claim 13 that further includes indicating means for providing a signal when the adhesive is activated.

21. A method of forming a braze-free connection between a refrigerant line and a component part of an air conditioning system that includes the steps of:
securing a first end of a flow connector having a central flow passage to a component part of an air conditioning system so that said central passage of the flow connector is in fluid flow communication with said component part;
surrounding a section of the passage with a radially expanded cavity;
passing a refrigerant line into a second end of the flow connector so that the line passes through the cavity;
filling the cavity with a pressure activated adhesive; and
pressure activating said adhesive so that a leak tight connection is formed between the refrigerant line and the connector.

22. The method of claim 21 that includes the further step of sealing both ends of said cavity.
